(19) United States
(12) Patent Application Publication
(10) Pub. No.: US 2007/0030783 A1
(43) Pub. Date: Feb. 8, 2007

(54) Disc drive apparatus, and method for timing reccalibration in a disc drive apparatus

(76) Inventors: Tony Petrus Van Endert, Eindhoven (NL); Antonius Jacobus Josephus Van Den Hoogen, Eindhoven (NL); Bart Granco, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/557,644

(22) PCT Filed: May 12, 2004
(86) PCT No.: PCT/IB04/50652

§ 371 Date: Nov. 17, 2005

(30) Foreign Application Priority Data
May 19, 2003 (EP) 03101403.8

(51) Int. Cl. G11B 7/00

(52) U.S. Cl. 369/53.37

(57) ABSTRACT

A disc drive apparatus (1) is described, comprising a data engine system (20) and a data processing system (30) in data communication with each other. The data engine system (20) and the data processing system (30) are also in a conferring communication with each other regarding the timing of recalibration. The data engine system (20) is designed to determine (step 120; 320) a moment when a recalibration procedure would be desirable, and to send (step 121; 321) a recalibration request signal to the data processing system (30). The data processing system (30) may or may not send (step 230; 430) a recalibration permission signal to the data engine system (20). The data engine system (20) only performs (step 132; 332) a recalibration procedure after having received the recalibration permission signal from the data processing system (30).

### FIELD OF THE INVENTION

The present invention relates in general to the art of storage devices such as optical storage discs. More particularly, the present invention relates in general to a disc drive apparatus for writing/reading information into/from an optical storage disc; hereinafter, such disc drive apparatus will also be indicated as “optical disc drive”.

### BACKGROUND OF THE INVENTION

As is commonly known, an optical storage disc comprises at least one track, either in the form of a continuous spiral or in the form of multiple concentric circles, of storage space where information may be stored in the form of a data pattern. Optical discs may be read-only type, where information is recorded during manufacturing, which information can only be read by a user. The optical storage disc may also be a writable type, where information may be stored by a user. For reading/writing information from/into the storage space of the optical storage disc, an optical disc drive comprises, on the one hand, rotating means for receiving and rotating an optical disc, and on the other hand optical means for generating an optical beam, typically a laser beam, and for scanning the storage track with said laser beam. Since the technology of optical discs in general, the way in which information can be stored in an optical disc, and the way in which optical data can be read from an optical disc, is commonly known, it is not necessary here to describe this technology in more detail.

In a disc drive, several operational parameters need to be calibrated, i.e. set to an optimal value for optimal performance. For example, a tilt angle of an optical lens is calibrated, a focus offset of an optical pickup unit is calibrated, a radial error amplitude is calibrated, etc. Particularly, in the case of a write operation, the optical write power is calibrated. Said parameters are commonly known to persons skilled in this art, as is the requirement for calibration. Further, calibration procedures for the above-mentioned and other parameters are known per se, and may be used in implementing the present invention. Therefore, a more detailed description of calibration procedures is not necessary here.

It is already known in practice to perform calibration procedures as part of a start-up procedure or initiation procedure, ie. when a new disc is introduced in the disc drive, and/or when a new read/write command is given in respect of a disc already present in the drive. However, it may be that the parameter values as set during start-up calibration are no longer optimal values at a later stage of the read/write process. This may, for instance, be due to changing circumstances like changing temperature, changing read/write location on disc, etc. Therefore, it may be desirable to also perform calibration procedures at a later stage, when a write or read process is in progress. Such calibration procedures will be indicated by the phrase “recalibration”, to make a distinction from calibration during the start-up phase.

An important aspect in recalibration is its timing. On the one hand, more frequent recalibration procedures may improve the signal quality, but it involves a reduction in data throughput. On the other hand, if recalibration procedures are performed not often enough, errors may occur. Further, recalibration procedures interrupt the write or read process which is in progress, so they could affect the proper data transfer.

### SUMMARY OF THE INVENTION

The present invention relates specifically to recalibration management, i.e. a decision-making process relating to the timing of recalibration.

It is a general objective of the present invention to provide a disc drive apparatus in which an optimal signal quality is maintained as much as possible.

It is a further general objective of the present invention to provide a disc drive apparatus in which recalibration procedures are performed at moments in time best suited in relation to data transfer.

It is a specific objective of the present invention to provide a disc drive apparatus with a recalibration management facility for assuring that the timing of recalibration does not adversely affect the proper data transfer.

According to an important aspect of the present invention, a method for determining a start time for a recalibration process is a two-step process. First, it is determined whether or not it has become desirable to execute a recalibration process. Then, instead of executing a recalibration process immediately when such has become desirable, it is checked whether the read/write process should be continued and the recalibration process should be postponed until a more suitable moment. A check is made for recalibration permission conditions, and the actual recalibration process only starts when all recalibration permission conditions are fulfilled. It may even be that the actual recalibration process does not start at all, because at least one of the recalibration permission conditions is not fulfilled.

By way of example of a recalibration permission condition, it may be that the disc drive is currently writing data from a data buffer (in a writing mode), and that the flow of data may not be disturbed until the buffer is empty. Or, it may be that, in a reading mode, the disc drive is outputting data to the host from a buffer which is almost empty and which should first be filled again in order to assure an undisturbed flow of data to the host.

In a preferred embodiment, a disc drive apparatus comprises a data engine system and a data processing system. The data engine system provides an interface between disc drive apparatus and disc, as it handles all incoming and outgoing communication between disc drive and disc. The data processing system processes the data present in incoming and outgoing signals from and to the disc, respectively, and processes the data for communication to and from a host system such as a PC, respectively. The recalibration timing is determined by the data engine system and the data processing system in cooperation

Specifically, the data engine system determines, on the basis of any criterion relating to disc interfacing, whether a recalibration should be performed. If the data engine system determines that a recalibration is due, it puts a request to the data processing system. The data processing system determines, on the basis of any criterion relating to data processing, whether it is allowed to perform the requested recalibration. If the data processing system determines that the requested recalibration is allowed, it sends a permission signal to the data engine system. The data engine system performs the recalibration procedure only after having forwarded a recalibration request signal to the data processing system and having received a recalibration permission signal from the data processing system.

### BRIEF DESCRIPTION OF THE DRAWINGS

These and other aspects, features and advantages of the present invention will be further explained by the following description of a preferred embodiment of the present invention with reference to the drawings, in which same reference numerals indicate same or similar parts, and in which:

FIG. 1 schematically shows a block diagram illustrating relevant parts of a disc drive apparatus;

FIG. 2 schematically shows a block diagram illustrating relevant parts of a control circuit;

FIG. 3A is a flow diagram schematically illustrating one method of determining recalibration timing in accordance with the present invention, in the case of a read operation;

FIG. 3B is a flow diagram illustrating the cooperation of a data engine system and a data processor in a read mode;

FIG. 3C is a flow diagram illustrating a variation of the procedure of FIG. 3B;

FIG. 4A is a flow diagram schematically illustrating one method of determining recalibration timing in accordance with the present invention, in the case of a write operation;

FIG. 4B is a flow diagram illustrating the cooperation of a data engine system and a data processor in a write mode;

FIG. 4C is a flow diagram illustrating a variation of the procedure of FIG. 4B.

### DESCRIPTION OF THE INVENTION

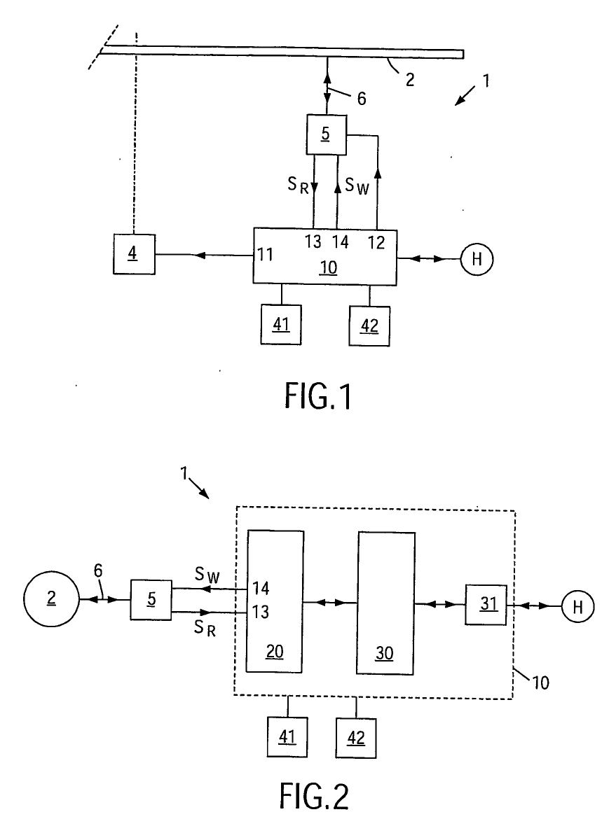

FIG. 1 schematically shows a diagram which illustrates some parts of a disc drive apparatus 1, capable of handling a disc 2. For instance, the disc 2 is an optical (including magneto-optical) disc, such as a CD, a DVD, etc. The disc drive 1 comprises a motor 4 for rotating the disc 2, and an optical pickup unit 5 for scanning tracks (not shown) of the disc 2 with an optical beam 6.

The disc drive 1 further comprises a control circuit 10, having a first output 11 for controlling the motor 4, and having a second output 12 for controlling the optical pickup unit 5. The control circuit 10 further has a data input port 13 and a data output port 14. In a reading mode, the data input port 13 receives a data read signal S_{R} from the optical pickup unit 5. In a writing mode, the control circuit 10 provides a data write signal S_{W} at its data output port 14. The control circuit 10 further has a data communication port 15 for data communication with a host system, generally indicated at H. The host system H may for instance be a PC or the like. The disc drive 1 may be separate from the host 1, communicating over a long-distance communication path, or it may be built-in in the host H.

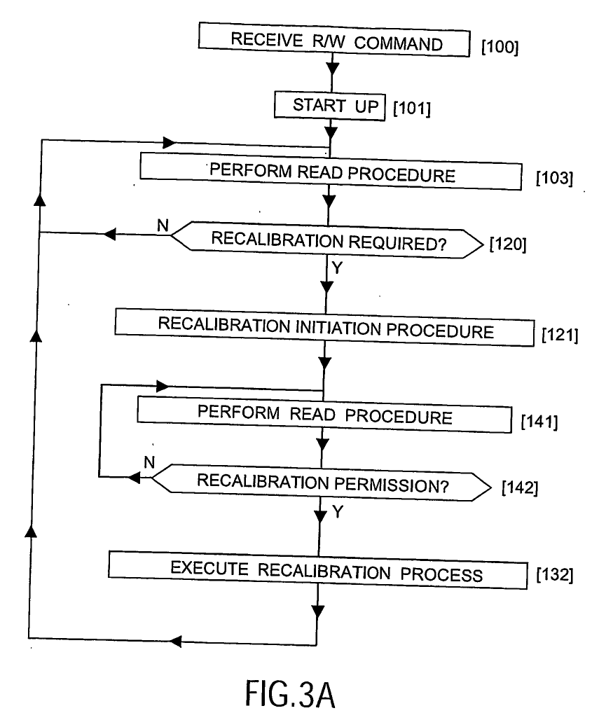

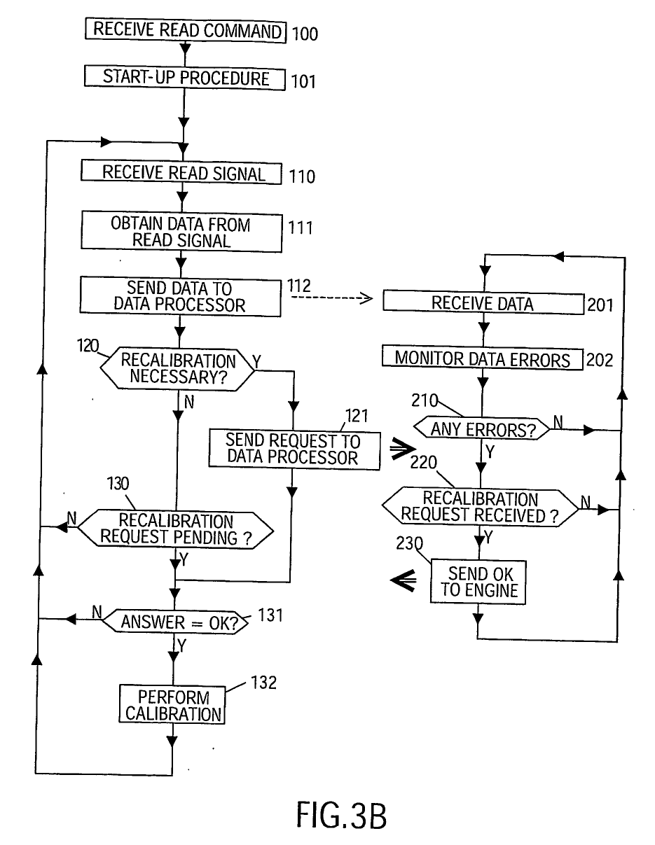

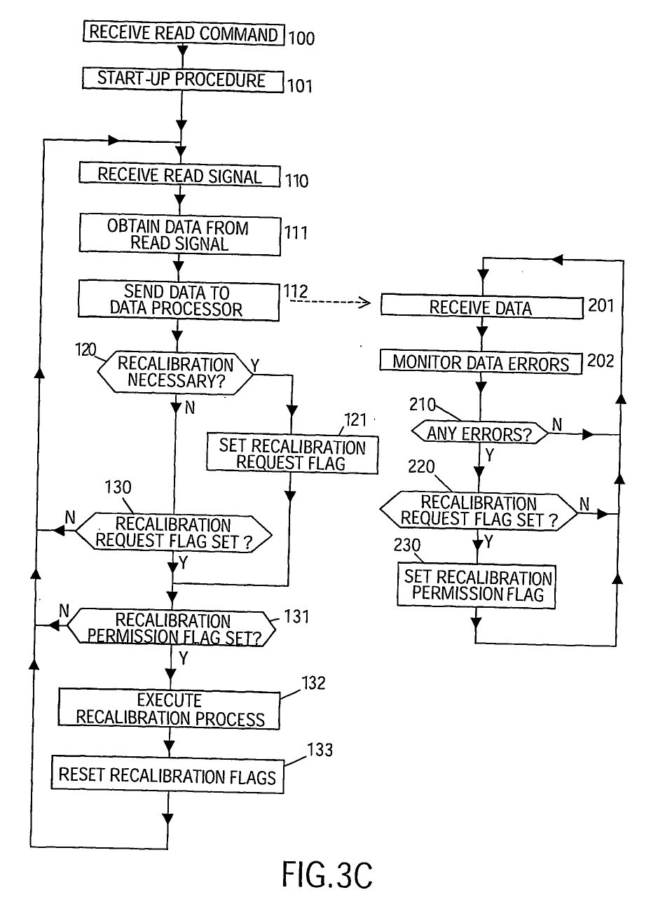

FIG. 3A is a flow diagram schematically illustrating one method of determining recalibration timing in accordance with the present invention, in the case of a read operation. When a read command is received [step 100] and after start-up [step 101], the read procedure [step 103] starts. It is noted that the start-up may also be performed beforehand.

During the read procedure, it is checked whether it becomes desirable to execute a recalibration process [step 120]. The criterion or criteria for deciding that a recalibration process is required may be any suitable criterion. By way of non-restricting example, it may be that a certain time since a previous calibration has passed.

If it is found that a recalibration process is required, a recalibration initiation procedure is executed [step 121].

After this recalibration initiation procedure, the read procedure continues [step 141], during which recalibration permission conditions are checked [step 142]. Only when all recalibration permission conditions are fulfilled, a recalibration process is executed [step 132]. Thus, the actual start of the recalibration process may be later than the moment when a recalibration process becomes due.

After completion of the recalibration process, the read procedure continues and the process is repeated, indicated as a jump back to step 103.

FIG. 2 schematically shows a diagram which illustrates a preferred embodiment of the control circuit 10 in somewhat more detail. Specifically, the control circuit 10 comprises a data engine system 20 and a data processing system 30. The data engine system 20, hereinafter simply indicated as “engine”, provides an interface between disc drive apparatus and disc, as it handles all incoming and outgoing communication between disc drive 1 and disc 2.

The data processing system 30, hereinafter simply indicated as “processor”, processes the data present in incoming and outgoing signals S_{R} and S_{W} from and to the disc, respectively, and processes the data for communication to and from a host system such as a PC, respectively.

Specifically, the engine 20 provides all functionality for communication with the disc 2. In a read mode, it controls the laser and processes the optical read signal such as to derive a data signal, which is further processed by the processor 30. In a write mode, the processor 30 provides a data signal to be written, which is received by the engine 20 who generates an appropriate write signal and controls the laser accordingly.

FIG. 3B is a flow diagram illustrating the cooperation of the engine 20 (steps 100-132) and the processor (steps 201-230) in a read mode.

If the engine receives a read command [step 100], it may first execute a start-up procedure [step 101], which includes one or more calibrations, such as for example tilt calibration, focus offset calibration, radial error calibration, etc.

After completion of the start-up procedure, the control circuit 10 drives the disc motor 4 and the optical pickup unit 5 for reading information from disc. The engine 20 receives the read signal S_{R} [step 110], processes the read signal S_{R} to obtain the data from the read signal S_{R} [step 111], and transfers this data to the processor 30 [step 112].

Further, the engine 20 determines whether any recalibration is necessary [step 120]. One factor which may possibly be used to determine whether a recalibration is necessary is entry into a new disc zone. As is known per se, discs are usually not perfectly homogeneous, i.e. material properties and/or optical properties and/or mechanical properties of the disc are usually not constant over the entire surface of the disc. It is already known to virtually divide a disc into adjacent disc zones, defined by an inner radius and an outer radius (the outer radius of zone x is the inner radius of zone x+1), and to perform a recalibration as soon as the read process reaches a new zone. Therefore, in one embodiment of the present invention, the engine 20 determines, in step 120, whether a new zone is reached, and if so, it decides that a recalibration is necessary.

If, in step 120, the engine 20 determines that recalibration is necessary, it sends a recalibration request signal to the data processor 30 [step 121].

In step 131, the engine 20 checks whether it has received a permission signal from the data processor 30. If not, the engine 20 continues the read process, as illustrated by a jump to step 110.

If, in step 120, the engine 20 determines that recalibration is not necessary, it checks [step 130] whether it has previously sent a recalibration request signal to the processor 30, which request has not been answered yet If it finds that a recalibration request signal is still pending, the engine 20 continues to check whether it has received a permission signal from the data processor 30 [step 131], otherwise the engine 20 continues the read process, as illustrated by a jump to step 110.

On the other hand, the data processor 30 receives [step 201] the data transferred by the engine 20, and monitors the quality of the signals received by looking for the occurrence of any data errors [step 202]. As long as no data errors occur [step 210], the data processing by the processor 30 simply continues, as illustrated by a jump to step 201. This data processing may include outputting the data at output 15 to host 2, but this is not illustrated in FIG. 3.

Only if the processor 30 finds, in step 210, that one or more errors have occurred in the data received from the engine 20, it checks [step 220] whether it had already received a recalibration request signal from the engine 20. If not, the processor 30 continues the data processing, as illustrated by a jump to step 201.

If the processor 30 finds, in step 220, that it had already received a recalibration request signal from the engine 20, the fact that data errors appear to occur are reason for the processor 30 to send a permission signal to the engine 20 [step 230].

In response to receiving this permission signal, the engine 20 enters a calibration mode [step 132], in which at least one parameter is calibrated. In a preferred embodiment, the engine 20 performs the same calibrations as during the start-up procedure.

After completing the calibration procedures, and after cancelling the pending recalibration request, the engine 20 leaves the calibration mode and continues the reading process at step 110.

The recalibration procedure may not take too long, because this may result in a data buffer underflow. Thus, if the recalibration has failed, the engine 20 continues the reading process, and it also sends a fresh recalibration request, recalibration to be executed after permission from the processor 30, as explained above.

Thus, it is assured that recalibration procedures are performed if the engine 20 finds that such procedures are due, but only if it appears useful with a view to reducing data errors. If no data errors occur, as determined by the data processor 30, recalibration is considered unnecessary. On the other hand, the mere fact that an error occurs is no reason for immediate recalibration. Thus, the data processor 30 does not decide to initiate recalibration, it only gives permission to the engine 20 to perform recalibration if the engine 20 has found that recalibration was due.

FIG. 3C is a flow diagram illustrating a variation of the procedure of FIG. 3B. In this case, the control circuit 10 comprises a first memory location 41, the contents of which being indicative for the fact that, in step 120, it has been found that a recalibration is required or due. This first memory location will be indicated as recalibration request flag. The recalibration initiation procedure of step 121 (FIG. 3A) comprises the step of setting the recalibration request flag.

The control circuit 10 further comprises a second memory location 42, the contents of which being indicative for the fact that all recalibration permission conditions are fulfilled. This second memory location will be indicated as recalibration permission flag. In the case of a read procedure, this flag is set once read errors are detected. The step of checking for recalibration permission (FIG. 3A, step 142) comprises the step of checking the recalibration permission flag 42.

The recalibration process of step 132 is executed only if both flags are set. After completion of the recalibration process, both flags are reset [step 133].

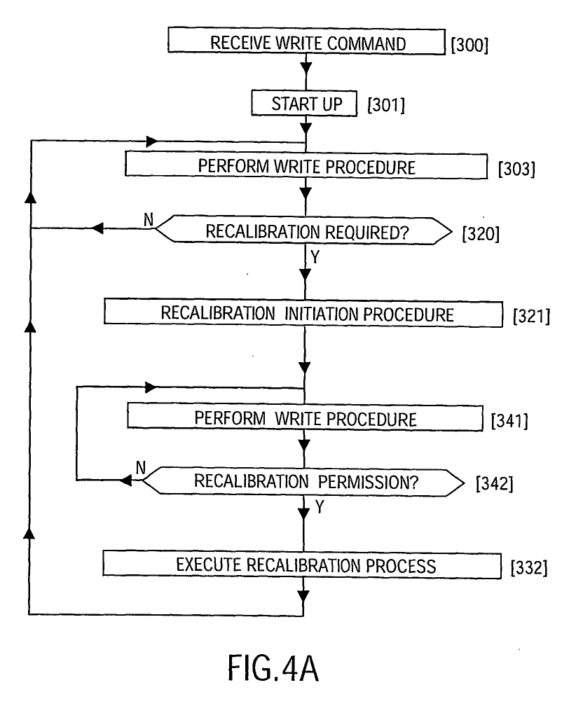

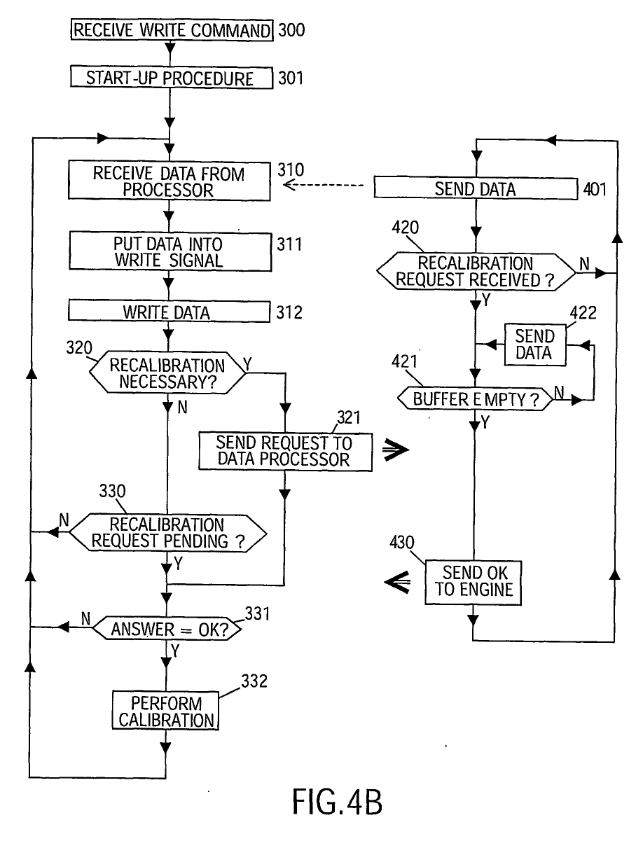

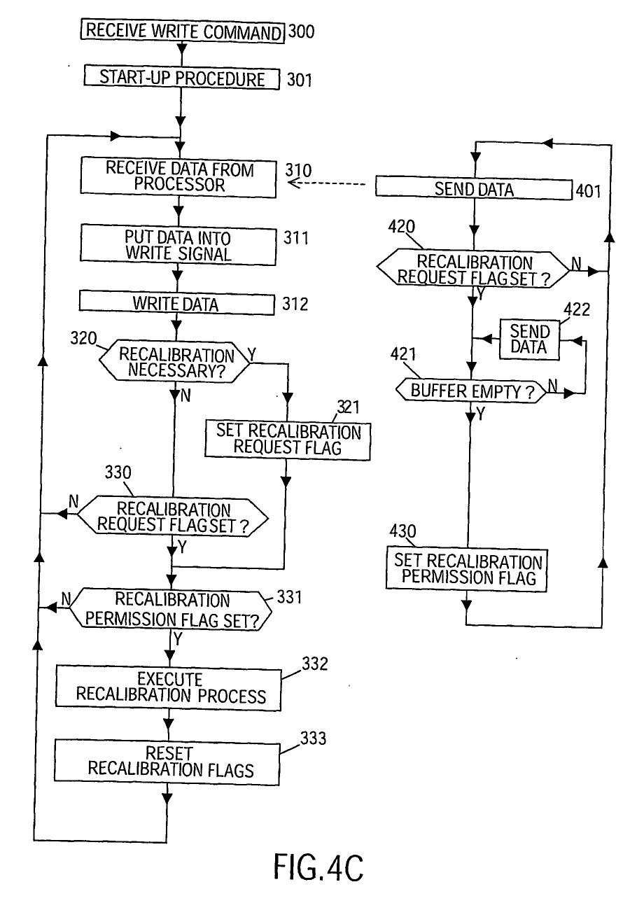

FIG. 4A is a flow diagram schematically illustrating one method of determining recalibration timing in accordance with the present invention, in the case of a write operation When a write command is received [step 300] and after start-up [step 301], the write procedure [step 303] starts. It is noted that the start-up may also be performed beforehand.

During the write procedure, it is checked whether it becomes desirable to execute a recalibration process [step 320]. The criterion or criteria for deciding that a recalibration process is required may be any suitable criterion By way of non-restricting example, it may be that a certain time since a previous calibration has passed.

If it is found that a recalibration process is required, a recalibration initiation procedure is executed [step 321].

After this recalibration initiation procedure, the write procedure continues [step 341], during which recalibration permission conditions are checked [step 342]. Only when all recalibration permission conditions are fulfilled, a recalibration process is executed [step 332]. Thus, the actual start of the recalibration process may be later than the moment when a recalibration process becomes due.

After completion of the recalibration process, the write procedure continues and the process is repeated, indicated as a jump back to step 303.

FIG. 4B is a flow diagram illustrating the cooperation of the engine 20 (steps 300-332) and the processor (steps 400-430) in a write mode.

If the engine receives a write command [step 300], it may first execute a start-up procedure [step 301], which includes one or more calibrations, such as for example tilt calibration, focus offset calibration, radial error calibration, etc.

After completion of the start-up procedure, the control circuit 10 drives the disc motor 4 and the optical pickup unit 5 for writing information to disc. The engine 20 receives from the processor 30 data to be written [step 310], processes this data to provide a write signal S_{W} [step 311], and writes this write signal S_{W} to the disc 2 [step 312].

Further, the engine 20 determines whether any recalibration is necessary [step 20]. In this determination, the engine 20 may take the same considerations into account as already discussed before in the context of reading. Therefore, in one embodiment of the present invention, the engine 20 determines, in step 320, whether a new zone is reached, and if so, it decides that a recalibration is necessary.

If, in step 320, the engine 20 determines that recalibration is necessary, it sends a recalibration request signal to the data processor 30 [step 321].

In step 331, the engine 20 checks whether it has received a permission signal from the data processor 30. If not, the engine 20 continues the writing process, as illustrated by a jump to step 310.

If, in step 320, the engine 20 determines that recalibration is not necessary, it checks [step 330] whether it has previously sent a recalibration request signal to the processor 30, which request has not been answered yet If it finds that a recalibration request signal is still pending, the engine 20 continues to check whether it has received a permission signal from the data processor 30 [step 331], otherwise the engine 20 continues the writing process, as illustrated by a jump to step 310.

On the other hand, the data processor 30 transfers [step 401] data the engine 20, such as data received from the host

The data processor 30 normally has no information regarding possible write errors, hence it can not decide whether recalibration is useful or not, therefore it is not competent to reject the recalibration request from the engine 20. However, the data processor 30 may find that now is not a suitable moment for recalibration, so it is competent to delay the recalibration process to a more suitable time. In this case, the delay time should not become excessively large; preferably, it should be less than 1 sec.

As one example of considerations for the processor to decide whether to allow or delay the recalibration process is the desirability to finish a current write step. For instance, the data may be written from a buffer 31 filled by the host, and it may be desirable to write the entire buffer contents in one continuous, i.e. uninterrupted writing process.

Thus, in step 420, the processor 30 checks whether it has received a recalibration request signal from the engine 20. If not, the processor 30 continues the data processing, as illustrated by a jump to step 401.

If the processor 30 finds, in step 420, that it has received a recalibration request signal from the engine 20, the processor 30 sends a permission signal to the engine 20 [step 430], either immediately or after some delay. In the example of FIG. 4B, the processor 30 assures that said buffer 31 is emptied [steps 421 and 4221] before sending a permission signal.

In response to receiving this permission signal, the engine 20 enters a calibration mode [step 332], in which at least one parameter is calibrated. In a preferred embodiment, the engine 20 performs the same calibrations as during the start-up procedure.

After completing the calibration procedures, and after cancelling the pending recalibration request, the engine 20 leaves the calibration mode and continues the writing process at step 310. The processor 30 continues sending data to the engine 20 (jump to step 401) only after having received a continuation message from the engine 20 that it has left the calibration mode, but this is not shown in FIG. 4B.

The recalibration procedure may not take too long, because this may result in a data buffer overflow. Thus, if the recalibration has failed, the engine 20 sends its continuation message to the processor 30, and it also sends a fresh recalibration request, recalibration to be executed after permission from the processor 30, as explained above.

Thus, it is assured that recalibration procedures are performed if the engine 20 finds that such procedures are due, but only at a suitable moment as determined by the data processor 30. If the present moment is not suitable, recalibration is delayed. Again, the data processor 30 does not decide to initiate recalibration, it only gives (possibly delayed) permission to the engine 20 to perform recalibration if the engine 20 has found that recalibration was due.

FIG. 4C is a flow diagram illustrating a variation of the procedure of FIG. 4B. In this case, the control circuit 10 comprises the recalibration request flag 41 and the recalibration permission flag 42 as explained earlier. The recalibration initiation procedure of step 321 (FIG. 4A) comprises the step of setting the recalibration request flag 41, while the step of checking for recalibration permission (FIG. 4A, step 342) comprises the step of checking the recalibration permission flag 42.

In the case of a write procedure, the recalibration permission flag 42 is set once all recalibration permission conditions are fulfilled, for instance when a write buffer is emptied.

The recalibration process of step 332 is executed only if both flags are set. After completion of the recalibration process, both flags are reset [step 333].

It should be clear to a person skilled in the art that the present invention is not limited to the exemplary embodiments discussed above, but that various variations and modifications are possible within the protective scope of the invention as defined in the appending claims.

For instance, in the exemplary embodiment of a read process described above, recalibration permission is granted once read errors are detected. However, it is also possible that the data is outputted from a buffer 31 to a host H which expects an undisturbed data stream, such as for instance in the case of a video application. If the buffer is almost empty, the recalibration process should be delayed, and recalibration permission is only granted until such time when the buffer is sufficiently filled to ensure an undisturbed data stream from the buffer 31 during the recalibration process.

In the above, the present invention has been explained in the context of optical storage discs. However, the gist of the present invention is not restricted to optical storage discs, but is generally applicable to storage devices in general

In the above, the present invention has been explained with reference to block diagrams, which illustrate functional blocks of the device according to the present invention It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, etc.

1. Method for timing at least one recalibration process in a storage write/read apparatus (1) when writing/reading information into/from a storage medium (2), the method comprising the steps of:
determining a due time for a recalibration process;
when a recalibration process is due, delaying the actual start of the recalibration process until such time when predetermined recalibration permission conditions are fulfilled.

2. Method according to claim 1, wherein, when a recalibration process is due, the recalibration permission conditions are checked and the recalibration process is started as soon as all recalibration permission conditions are fulfilled.

3. Method according to claim 1, wherein, in a reading mode, the actual start of the recalibration process is postponed until read errors occur.

4. Method according to claim 1, wherein, in a reading mode, the actual start of the recalibration process is postponed until a data buffer is sufficiently filled.

5. Method according to claim 1, wherein, in a writing mode, the actual start of the recalibration process is postponed until a data buffer is sufficiently emptied.

6. Method according to claim 1, wherein the write/read operation is continued until the start of an actual recalibration process.

7. Storage write/read apparatus (1) for writing/reading information into/from a storage medium (2), the apparatus being designed for performing the method according to claim 1.

8. Storage write/read apparatus (1) according to claim 7, the apparatus being a disc drive apparatus for writing/reading information into/from a storage disc (2), for instance an optical storage disc.

9. Storage write/read apparatus (1), capable of writing/reading information into/from a storage medium (2), the apparatus comprising a control circuit (10) designed to perform a recalibration procedure during a write or read process;
the control circuit (10) designed to time at least one recalibration process in accordance with the method of any claim 1.

10. Storage write/read apparatus (1) according to claim 9,
the control circuit (10) being associated with a first flag (41) and a second flag (42);
the control circuit (10) being designed to:
determine a due time for a recalibration process;
set the first flag when this due time is reached;
check predetermined recalibration permission conditions;
set the second flag when all predetermined recalibration permission conditions are fulfilled;
execute a recalibration process when both the first flag and the second flag are set.

11. Storage write/read apparatus (1) according to claim 9;
the apparatus comprising a data engine system (20) and a data processing system (30) in data communication with each other;
wherein the data engine system is designed, in a reading mode, for receiving read signals (SR), deriving data signals from the read signals, and communicating the data signals to the data processing system, and in a writing mode, for receiving data signals from the data processing system and generating write signals (SW);
wherein the data processing system is designed, in a reading mode, for receiving data signals from the data engine system and processing the data for communication to a host system (H), and in a writing mode, for communication with a host system, processing data signals in the communication signals received from the host system, and communicating data signals to the data engine system;
wherein the data engine system (20) and the data processing system (30) are also in communication with each other regarding the timing of recalibration.

12. Disc drive apparatus according to claim 11, wherein the data engine system (20) is designed to determine (step 120; 320) a moment when a recalibration procedure would be desirable, and to send (step 121; 321) a recalibration request signal to the data processing system (30);
wherein the data processing system (30) is designed to decide on sending (step 230; 430) a recalibration permission signal to the data engine system (20);
wherein the data engine system (20) is designed to only perform (step 132; 332) a recalibration procedure after having received the recalibration permission signal from the data processing system (30).

13. Disc drive apparatus according to claim 12, wherein, in a reading mode, the data engine system (20) is designed to check whether a recalibration permission signal has been received from the data processing system (30) in respect of a pending recalibration request (steps 130-131), and if not, to continue with receiving and processing the read signal (step 110), otherwise to perform the recalibration process (step 132) and continue with receiving and processing the read signal (step 110) only after having completed the recalibration process.

14. Disc drive apparatus according to claim 13, wherein the data engine system (20), if the recalibration process is unsuccessful, is designed to continue with receiving and processing the read signal (step 110) and to immediately send a new recalibration request signal (step 121).

15. Disc drive apparatus according to claim 12, wherein, in a reading mode, the data processing system (30) is designed to send the recalibration permission signal only if it finds that data errors occur in the data received from the data engine system (20).

16. Disc drive apparatus according to claim 15, wherein the data processing system (30) is designed to continuously monitor (step 202) the data received from the data engine system (20) on the occurrence of data errors; if it finds a data error (step 210), to check whether it had already received a recalibration request signal (step 220), and if so, to send the recalibration permission signal (step 230), otherwise to continue receiving and processing data as received from the data engine system (20) (step 201).

17. Disc drive apparatus according to claim 12, wherein, in a writing mode, the data engine system (20) is designed to check whether a recalibration permission signal has been received from the data processing system (30) in respect of a pending recalibration request (steps 330-331), and if not, to continue with receiving data and generating the write signal (steps 310-312), otherwise to perform the recalibration process (step 332) and continue with receiving data and generating the write signal (steps 310-312) only after having completed the recalibration process.

18. Disc drive apparatus according to claim 17, wherein the data engine system (20), if the recalibration process is unsuccessful, is designed to continue with receiving data and generating the write signal (steps 310-312) and to immediately send a new recalibration request signal (step 321).

19. Disc drive apparatus according to claim 17, wherein the data engine system (20), after having completed the recalibration process, is designed to send a continuation signal to the data processing system (30).

20. Disc drive apparatus according to claim 12, wherein, in a writing mode, the data processing system (30) is designed to send the recalibration permission signal only at a time appropriate such as not to disturb data traffic with the host or such as not to disturb the data writing process.

21. Disc drive apparatus according to claim 20, wherein the data processing system (30) is designed to delay sending the recalibration permission signal until a data buffer (31) has been emptied.

22. Disc drive apparatus according to claim 21, wherein the data processing system (30) is designed to continuously monitor (step 420) whether it has received a recalibration request signal from the data engine system (20), and if so, to continue sending data to the data engine system (20) from the data buffer (31) until this data buffer (31) is empty (steps 421-422) and then send the recalibration permission signal to the data engine system (20) (step 430).

23. Disc drive apparatus according to claim 22, wherein the data processing system (30), after having sent the recalibration permission signal, is designed to wait until receiving a continuation signal from the data engine system (20) before continuing with sending data to the data engine system (20) from the data buffer (31) (step 401).
